(19) United States
(12) Patent Application Publication
(10) Pub. No.: US 2024/0327629 A1
(43) Pub. Date: Oct. 3, 2024

(54) CROSSLINKED POLYETHYLENE FOAM

(71) Applicant: Toray Plastics (America), Inc., North Kingstown, RI (US)

(72) Inventors: Jesse Jude BALDWIN, Strasburg, VA (US); Tyler Austin BOWMAN, Stephenson, VA (US); Pawel SIERADZKI, Winchester, VA (US)

(73) Assignee: Toray Plastics (America), Inc., North Kingstown, RI (US)

(21) Appl. No.: 18/194,316

(22) Filed: Mar. 31, 2023

(51) Int. Cl. C08L 23/06; B32B 5/18; B32B 5/32; B32B 25/04; B32B 27/06; B32B 27/28; B32B 27/30; B32B 27/32; B32B 27/40; C08J 9/00; C08J 9/10; C09J 7/26; C09J 7/38

(52) U.S. Cl. CPC C08L 23/06; B32B 5/18; B32B 5/32; B32B 25/045; B32B 27/065; B32B 27/283; B32B 27/308; B32B 27/32; B32B 27/40; C08J 9/0061; C08J 9/103; C09J 7/26; C09J 7/38; B32B 5/022; B32B 5/245; B32B 9/025; B32B 9/046; B32B 27/304; B32B 2262/0253; B32B 2262/0276; B32B 2266/025; B32B 2266/08; B32B 2274/00; B32B 2307/72; B32B 2307/7376; B32B 2405/00; C08J 2203/04; C08J 2205/044; C08J 2205/052; C08J 2323/06; C08J 2423/06; C08J 2453/00; C08L 2201/08; C08L 2203/14; C08L 2205/025; C08L 2205/03; C08L 2205/06; C08L 2207/066; C08L 2310/00; C09J 2301/124; C09J 2301/302; C09J 2301/414; C09J 2423/006; C09J 2453/006

(57) ABSTRACT

Described herein are physically crosslinked, closed cell continuous foam structures comprising low density polyethylene (LDPE), linear low density polyethylene (LLDPE), or a combination of LDPE and LLDPE, and olefin block copolymer (OBC). The foam structure can be obtained by extruding a foam composition comprising LDPE, LLDPE, or a combination of LDPE and LLDPE, and OBC, irradiating the composition with ionizing radiation, and foaming the composition.

### FIELD OF THE DISCLOSURE

This invention relates generally to crosslinked polyethylene foam structures, and more specifically, to crosslinked polyethylene foam structures produced from a blend of polyethylene and polyethylene-based olefin block copolymer.

### BACKGROUND OF THE DISCLOSURE

Crosslinked polyethylene foam sheets are used in numerous applications: as a substrate in tape, as a gasket, as a layer or component in automotive interior trim, as protection in packaging and transportation, as a component in flotation devices and buoyancy aids, as a component in clothing and footwear, as a component in mattresses and bedding, as insulation for walls and pipes, as padding for furniture, as flooring underlayment, as a vibration dampener, as an impact dampener, etc. These crosslinked polyethylene foams are commonly produced from low density polyethylene (LDPE) and/or traditional multi-site Ziegler-Natta type catalyzed linear low density polyethylene (LLDPE). A subset of crosslinked polyethylene foams are crosslinked foams produced from a blend of polyethylene (LDPE and/or traditional LLDPE) and ethylene vinyl acetate copolymer (EVA). EVA is commonly used to increase the softness and flexibility of crosslinked polyethylene foam sheets for applications requiring increased softness and flexibility that is not normally attainable from LDPE and/or traditional LLDPE.

One of the raw materials required for the production of EVA copolymer is vinyl acetate monomer (VAM). VAM is a raw material used not just for the production of EVA copolymer but used heavily in dispersion adhesives in the automobile, building, furniture, and paper/packaging industries. VAM is also a raw material in paints and coatings, construction, and textile manufacturing. However, a global shortage of VAM has caused demand for VAM to exceed supply, with no foreseeable abatement in the future. Consequently, the worldwide shortfall of VAM has resulted in dramatic price increases and price swings for VAM and, on a larger scale, all products requiring VAM—including EVA.

### SUMMARY OF THE DISCLOSURE

It has been discovered that it is possible to produce physically crosslinked, closed cell polyethylene foam structures from a blend of polyethylene (LDPE and/or traditional LLDPE) and polyethylene-based olefin block copolymer (OBC). Whereas a subset of commercially produced polyethylene foams are crosslinked foams produced from a blend of polyethylene (LDPE and/or traditional LLDPE) and EVA copolymer, it has been discovered that blending OBC rather than EVA into the foam formulation can also suitably increase the softness and flexibility of crosslinked polyethylene foam sheets for applications requiring increased softness and flexibility that is not normally attainable from LDPE and/or traditional LLDPE alone. Since OBC is not in short supply now nor in the foreseeable future, the discovered foam can be produced from readily available polymers. Also due to adequate production and supply of OBC, the raw material costs of the discovered foam are expected to be significantly more stable than the polyethylene foams (LDPE and/or traditional LLDPE) blended with EVA. Adequate quick supply and stable pricing are very desired by manufacturers of crosslinked foams, their distributors, and users of the crosslinked foams.

Polyethylene foam sheets can be obtained by (a) extruding a foam composition comprising a blend of polyethylene (LDPE and/or LLDPE) and polyethylene-based OBC, (b) irradiating the extruded foam composition with ionizing radiation, and (c) foaming the irradiated, extruded foam composition.

In some embodiments, a polyethylene foam structure includes 40-65 wt. % low density polyethylene (LDPE), linear low density polyethylene (LLDPE), or a combination of LDPE and LLDPE; and 15-45 wt. % olefin block copolymer (OBC). In some embodiments, the foam structure includes 50-65 wt. % low density polyethylene (LDPE), linear low density polyethylene (LLDPE), or a combination of LDPE and LLDPE. In some embodiments, the foam structure includes 20-35 wt. % olefin block copolymer (OBC). In some embodiments, the foam structure includes a chemical foaming agent in an amount of 5-15 wt. %. In some embodiments, the foam structure includes an antioxidant masterbatch in an amount of 1-10 wt. %. In some embodiments, the foam structure includes a processing aid masterbatch in an amount of 0.5-5 wt. %. In some embodiments, the foam structure includes a chemical foaming agent decomposition suppressant masterbatch in an amount of 1-10 wt. %. In some embodiments, the foam structure includes an anti-blocking agent masterbatch in an amount of 1-10 wt. %. In some embodiments, the foam structure includes a colorant masterbatch in an amount of 1-12 wt. %. In some embodiments, the foam structure has a density of 15-200 kg/m³. In some embodiments, the foam structure has a crosslinking degree of 20-75%. In some embodiments, the foam structure has an average closed cell size of 0.05-1.0 mm. In some embodiments, the foam structure has a thickness of 0.2-50 mm. In some embodiments, the foam structure is a monolayer.

In some embodiments, a laminate includes a polyethylene foam layer comprising: 40-65 wt. % low density polyethylene (LDPE), linear low density polyethylene (LLDPE), or a combination of LDPE and LLDPE; and 15-45 wt. % olefin block copolymer (OBC); and a laminate layer on a side of the polyethylene foam layer. In some embodiments, the laminate layer is a flexible film, fabric, or foil. In some embodiments, the laminate layer is unfoamed or foamed.

In some embodiments, an adhesive foam tape includes a polyethylene foam layer comprising: 40-65 wt. % low density polyethylene (LDPE), linear low density polyethylene (LLDPE), or a combination of LDPE and LLDPE; and 15-45 wt. % olefin block copolymer (OBC); and a pressure sensitive adhesive layer on a side of the polyethylene foam layer. In some embodiments, the tape includes a second pressure sensitive adhesive layer on a side of the polyethylene foam layer opposite from the first pressure sensitive adhesive layer. In some embodiments, either of the pressure sensitive adhesive layers comprises one or more of acrylic polymers, polyurethanes, thermoplastic elastomers, block copolymers, polyolefins, silicones, rubber-based adhesives, copolymers of ethylhexylacrylate and acrylic acid, copolymers of isooctyl acrylate and acrylic acid, or combinations thereof.

In some embodiments, a method of forming a polyethylene foam includes extruding a foam layer comprising: 40-65 wt. % low density polyethylene (LDPE), linear low density polyethylene (LLDPE), or a combination of LDPE and LLDPE; and 15-45 wt. % olefin block copolymer (OBC); irradiating the extruded foam layer with ionizing radiation; and foaming the irradiated, extruded foam layer. In some embodiments, the foam layer comprises 50-65 wt. % low density polyethylene (LDPE), linear low density polyethylene (LLDPE), or a combination of LDPE and LLDPE. In some embodiments, the foam layer comprises 20-35 wt. % olefin block copolymer (OBC). In some embodiments, the foam layer comprises a chemical foaming agent in an amount of 5-15 wt. % before foaming. In some embodiments, the foam layer comprises an antioxidant masterbatch in an amount of 1-10 wt. %. In some embodiments, the foam layer comprises a processing aid masterbatch in an amount of 0.5-5 wt. %. In some embodiments, the foam layer comprises a chemical foaming agent decomposition suppressant masterbatch in an amount of 1-10 wt. %. In some embodiments, the foam layer comprises an anti-blocking agent masterbatch in an amount of 1-10 wt. %. In some embodiments, the foam layer comprises a colorant masterbatch in an amount of 1-12 wt. %. In some embodiments, the foam layer has a melt flow index of 0.1-25 grams per 10 minutes at 190° C. In some embodiments, the foamed, irradiated, extruded foam layer has a density of 15-200 kg/m³. In some embodiments, the foamed, irradiated, extruded foam layer has an average closed cell size of 0.05-1.0 mm. In some embodiments, the foamed, irradiated, extruded foam layer has a thickness of 0.2-50 mm. In some embodiments, the ionizing radiation is selected from the group consisting of alpha, beta (electron), x-ray, gamma, and neutron. In some embodiments, the extruded foam layer is irradiated up to four separate times. In some embodiments, the ionizing radiation crosslinks the extruded foam layer to a crosslinking degree of 20-75%. In some embodiments, foaming comprises heating the irradiated, extruded foam layer with molten salt and radiant heaters or a hot air oven. In some embodiments, the method includes applying a laminate layer to a side of the foamed, irradiated, extruded foam layer. Ion some embodiments, the method includes applying a pressure sensitive adhesive layer to a side of the foamed, irradiated, extruded foam layer. In some embodiments, the method includes applying a second pressure sensitive adhesive layer to a side of the foamed, irradiated, extruded foam layer opposite from the first pressure sensitive adhesive layer.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

It is understood that aspects and embodiments described herein include “consisting” and/or “consisting essentially of” aspects and embodiments. For all methods, systems, compositions, and devices described herein, the methods, systems, compositions, and devices can either comprise the listed components or steps, or can “consist of” or “consist essentially of” the listed components or steps. When a system, composition, or device is described as “consisting essentially of” the listed components, the system, composition, or device contains the components listed, and may contain other components which do not substantially affect the performance of the system, composition, or device, but either do not contain any other components which substantially affect the performance of the system, composition, or device other than those components expressly listed; or do not contain a sufficient concentration or amount of the extra components to substantially affect the performance of the system, composition, or device. When a method is described as “consisting essentially of” the listed steps, the method contains the steps listed, and may contain other steps that do not substantially affect the outcome of the method, but the method does not contain any other steps which substantially affect the outcome of the method other than those steps expressly listed.

In the disclosure, “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

Additional advantages will be readily apparent to those skilled in the art from the following detailed description. The examples and descriptions herein are to be regarded as illustrative in nature and not restrictive.

### DETAILED DESCRIPTION OF EXEMPLARY EMBODIMENTS

Described are foam structures and methods of producing crosslinked, closed cell continuous polyethylene foam structures (e.g., films, layers, sheets, etc.) comprising low density polyethylene (LDPE), linear low density polyethylene (LLDPE), or a combination of LDPE and LLDPE, and olefin block copolymer (OBC). In some embodiments, the OBC can be a multi-block LLDPE copolymer containing harder crystallizable LLDPE copolymer “blocks” alternating with amorphous softer LLDPE copolymer “blocks” that are not randomly distributed—that is, in a controlled (non-random) block sequence. In some embodiments, the polyethylene foam structure can be obtained by (a) extruding a foam composition, (b) irradiating the extruded foam composition with ionizing radiation, and (c) foaming the extruded, irradiated composition.

In the extrusion step, raw materials of the foam composition can be fed into an extruder. The method of feeding ingredients into the extruder can be based on the design of the extruder and the material handling equipment available. Preblending ingredients of the foam composition may be performed, if necessary or desired, to facilitate their dispersal. If performed, a Henshel mixer may be used for preblending. In some embodiments, all ingredients can be preblended and fed thru a single port in the extruder. In some embodiments, the ingredients can also be individually fed thru separate designated ports for each ingredient or into a single port in the extruder. For example, if an ingredient is a liquid, the liquid can be added through a feeding gate (or gates) on the extruder or through a vent opening on the extruder (if equipped with a vent) instead of being preblended with solid ingredients. Combinations of preblending and individual ingredient port feeding can also be employed. Exemplary extrusion techniques are also disclosed in Chapter 8 of Handbook of Polymeric Foam and Foam Technology (2nd Edition, edited by Daniel Klempner and Vahid Sendijarevic), the subject matter of which is incorporated herein by reference in its entirety.

In some embodiments, the extruder can deliver a steady amount of a foam composition into a sheeting die to create an unfoamed sheet composition. The thickness of the unfoamed sheet can be controlled by the overall die gap. However, the sheet thickness can further be adjusted, for example, by stretching (i.e., “drawing”) the melted extrudate and/or flattening the melted extrudate through a nip. It is to be understood that the term foam structure as used herein incorporates various foam structures including but not limited to foam sheets, films, layers, etc.

A foam composition fed into the extruder can include low density polyethylene (LDPE), linear low density polyethylene (LLDPE), or a combination of LDPE and LLDPE, and olefin block copolymer (OBC). In some embodiments, the OBC can be a multi-block LLDPE copolymer containing harder crystallizable LLDPE copolymer “blocks” alternating with amorphous softer LLDPE copolymer “blocks” that are not randomly distributed—that is, in a controlled (non-random) block sequence.

In some embodiments, the foam composition fed into the extruder can be at least about 70 wt. %, at least about 75 wt. %, at least about 80 wt. %, or at least about 85 wt. % LDPE, LLPDE, OBC, or combinations thereof. In some embodiments, the foam composition fed into the extruder can be at most about 90 wt. %, at most about 87 wt. %, at most about 84 wt. %, or at most about 81 wt. % LDPE, LLPDE, OBC, or combinations thereof. In some embodiments, the foam composition fed into the extruder can be about 70-90 wt. %, about 75-87 wt. %, or about 80-84 wt. % LDPE, LLPDE, OBC, or combinations thereof.

In some embodiments, an amount of LDPE, LLDPE, or a combination of LDPE and LLDPE in the polyethylene foam composition fed into the extruder can be at least about 30 wt. %, at least about 35 wt. %, at least about 40 wt. %, at least about 45 wt. %, at least about 48 wt. %, at least about 50 wt. %, at least about 52 wt. %, at least about 55 wt. %, at least about 58 wt. %, or at least about 60 wt. % LDPE, LLDPE, or a combination of LDPE and LLDPE. In some embodiments, the amount of LDPE, LLDPE, or a combination thereof in the polyethylene foam composition fed into the extruder can be at most about 42 wt. %, at most about 45 wt. %, at most about 50 wt. %, at most about 52 wt. %, at most about 55 wt. %, at most about 58 wt. %, at most about 60 wt. %, at most about 62 wt. %, at most about 65 wt. %, at most about 68 wt. %, at most about 70 wt. %, or at most about 75 wt. % LDPE, LLDPE, or a combination of LDPE and LLDPE. In some embodiments, the amount of LDPE, LLDPE, or a combination thereof in the polyethylene foam composition fed into the extruder can be about 30-80 wt. %, about 35-75 wt. %, about 35-70 wt. %, about 40-65 wt. %, about 40-60 wt. %, about 40-55 wt. %, about 40-50 wt. %, about 45-65 wt. %, about 45-60 wt. %, about 45-55 wt. %, about 48-62 wt. %, about 48-60 wt. %, about 48-58 wt. %, about 50-65 wt. %, or about 50-60 wt. % LDPE, LLDPE, or a combination of LDPE and LLDPE.

In some embodiments, an amount of LDPE, LLDPE, or a combination of LDPE and LLDPE in the polyethylene foam composition fed into the extruder can be greater than or equal to about 15, 20, 25, 30, 35, 40, 45, or 50 PHR LDPE, LLDPE, or a combination of LDPE and LLDPE. In some embodiments, an amount of LDPE, LLDPE, or a combination of LDPE and LLDPE in the polyethylene foam composition fed into the extruder can be less than or equal to about 50, 55, 60, 65, 70, 75, 80, or 85 PHR LDPE, LLDPE, or a combination of LDPE and LLDPE. In some embodiments, an amount of LDPE, LLDPE, or a combination of LDPE and LLDPE in the polyethylene foam composition fed into the extruder can be about 15-85, 15-80, 15-75, 20-85, 20-80, 20-75, 50-85, 50-80, 50-75, 50-70, 50-65, 50-60, 60-85, 60-80, 60-75, 70-85, or 70-80 PHR LDPE, LLDPE, or a combination of LDPE and LLDPE.

In some embodiments, an amount of LDPE in the polyethylene foam composition fed into the extruder can be at least about 10 wt. %, at least about 15 wt. %, at least about 18 wt. %, at least about 20 wt. %, at least about 22 wt. %, at least about 24 wt. %, at least about 26 wt. %, at least about 30 wt. %, at least about 35 wt. %, at least about 38 wt. %, at least about 40 wt. %, at least about 42 wt. %, at least about 45 wt. %, at least about 48 wt. %, at least about 50 wt. %, or at least about 55 wt. % LDPE. In some embodiments, an amount of LDPE in the polyethylene foam composition fed into the extruder can be at most about 40 wt. %, at most about 45 wt. %, at most about 48 wt. %, at most about 50 wt. %, at most about 52 wt. %, at most about 55 wt. %, at most about 60 wt. %, at most about 62 wt. %, at most about 65 wt. %, at most about 70 wt. %, at most about 73 wt. %, at most about 75 wt. %, or at most about 80 wt. % LDPE. In some embodiments, an amount of LDPE in the polyethylene foam composition fed into the extruder can be about 10-80 wt. %, about 15-75 wt. %, about 20-70 wt. %, about 24-65 wt. %, about 20-30 wt. %, about 35-45 wt. %, about 35-55 wt. %, about 35-50 wt. %, about 45-55 wt. %, about 45-60 wt. %, about 50-60 wt. %, or about 50-65 wt. % LDPE.

In some embodiments, an amount of LDPE in the polyethylene foam composition fed into the extruder can be greater than or equal to about 20, 25, 30, 35, 40, 45, or 50 PHR LDPE. In some embodiments, an amount of LDPE in the polyethylene foam composition fed into the extruder can be less than or equal to about 50, 55, 60, 65, 70, 75, or 80 PHR LDPE. In some embodiments, an amount of LDPE in the polyethylene foam composition fed into the extruder can be about 20-80, 20-75, 25-80, 25-75, 30-80, 30-75, 30-70, 30-65, 30-60, 30-55, 30-50, 50-80, 50-75, 50-70, 50-60, 60-80, 60-75, or 70-80 PHR LDPE.

In some embodiments, an amount of LLDPE in the polyethylene foam composition fed into the extruder can be at least about 5 wt. %, at least about 8 wt. %, at least about 10 wt. %, at least about 12 wt. %, at least about 15 wt. %, at least about 17 wt. %, at least about 20 wt. %, at least about 22 wt. %, at least about 24 wt. %, at least about 25 wt. %, at least about 26 wt. %, at least about 30 wt. %, or at least about 35 wt. % LLDPE. In some embodiments, an amount of LLDPE in the polyethylene foam composition fed into the extruder can be at most about 30 wt. %, at most about 35 wt. %, at most about 40 wt. %, at most about 42 wt. %, at most about 44 wt. %, at most about 45 wt. %, at most about 46 wt. %, at most about 48 wt. %, at most about 50 wt. %, at most about 52 wt. %, at most about 55 wt. %, at most about 60 wt. %, or at most about 65 wt. % LLDPE. In some embodiments, an amount of LLDPE in the polyethylene foam composition fed into the extruder can be about 5-65 wt. %, about 5-60 wt. %, about 10-55 wt. %, about 15-50 wt. %, about 10-20 wt. %, about 10-30 wt. %, about 20-30 wt. %, about 20-40 wt. %, about 20-50 wt. %, about 20-55 wt. %, about 40-50 wt. %, about 40-55 wt. %, about 45-55 wt. %, or about 45-50 wt. % LLDPE.

In some embodiments, an amount of LLDPE in the polyethylene foam composition fed into the extruder can be greater than or equal to about 15, 20, 25, 30, 35, 40, 45, or 50 PHR LLDPE. In some embodiments, an amount of LLDPE in the polyethylene foam composition fed into the extruder can be less than or equal to about 50, 55, 57.5, 60, 65, or 70 PHR LLDPE. In some embodiments, an amount of LLDPE in the polyethylene foam composition fed into the extruder can be about 15-70, 15-65, 15-60, 20-70, 20-65, 20-60, 20-40, 20-30, 30-70, 30-65, 30-60, 50-70, 50-65, or 50-60 PHR LLDPE.

In some embodiments, an amount of OBC in the polyethylene foam composition fed into the extruder can be at least about 10 wt. %, at least about 15 wt. %, at least about 20 wt. %, at least about 22 wt. %, at least about 25 wt. %, at least about 27 wt. %, at least about 30 wt. %, at least about 32 wt. %, at least about 35 wt. %, at least about 38 wt. %, or at least about 40 wt. % OBC. In some embodiments, an amount of OBC in the polyethylene foam composition fed into the extruder can be at most about 20 wt. %, at most about 25 wt. %, at most about 30 wt. %, at most about 32 wt. %, at most about 35 wt. %, at most about 37 wt. %, at most about 40 wt. %, at most about 45 wt. %, at most about 48 wt. %, or at most about 50 wt. % OBC. In some embodiments, an amount of OBC in the polyethylene foam composition fed into the extruder can be about 10-50 wt. %, about 15-45 wt. %, about 20-40 wt. %, about 20-35 wt. %, about 20-30 wt. %, about 22-35 wt. %, about 22-32 wt. %, about 25-35 wt. %, about 30-45 wt. %, or about 30-40 wt. % OBC.

In some embodiments, an amount of OBC in the polyethylene foam composition fed into the extruder can be greater than or equal to about 15, 20, 25, 26, 30, 35, 40 PHR OBC. In some embodiments, an amount of OBC in the polyethylene foam composition fed into the extruder can be less than or equal to about 42, 42.5, 43, 45, 50, or 55 PHR OBC. In some embodiments, an amount of OBC in the polyethylene foam composition fed into the extruder can be about 15-55, 15-50, 15-45, 15-40, 20-55, 20-50, 20-45, 20-40, 25-55, 25-50, 25-45, 25-40, 25-35, 30-55, 30-50, 30-45, 30-40, 35-55, 35-50, 35-45, 40-55, or 40-50 PHR OBC.

Since a broad range of foam articles can be created with the disclosed foam composition, a broad range of LD, LLD, and OBC polyethylenes can be employed in the composition to meet various in-process manufacturing requirements and commercial end use requirements.

“LDPE” is low density polyethylene homopolymer commonly produced in high pressure tubular and autoclave reactors. In the reaction, gaseous ethylene monomer is polymerized under very high pressures and high temperatures in the presence of oxide initiators to produce a polymer structure with long and short branches. LDPE is one of the most widely commercially produced commodity thermoplastic worldwide and manufactured by both by large multinational corporations (Dow, ExxonMobil, LyondellBasell, Sinopec, PetroChina, SABIC, Borealis, etc.) and mid-to-smaller companies (Westlake, Nova, Japan Polyethylene, Repsol, PKN Orlen, Carmel, etc.) Non-limiting examples of commercial LDPE grades are marketed under various tradenames. For example, the LDPE manufacturers listed above sell commercial grades under the tradenames Dow™ LDPE (Dow), ExxonMobil™ LDPE (ExxonMobil), SINOPEC LDPE, (Sinopec), SABIC® LDPE, Borealis LDPE, Westlake Polyethylene™ (Westlake), NOVAPOL® (Nova), NOVATEC®-LD (Japan Polyethylene), Repsol Alcudia and Repsol PE Ultraclean® (Repsol), Malen (PKN Orlen), and Ipethene® (Carmel).

“LLDPE” is linear low density polyethylene commonly produced in low pressure fluidized bed reactors at significantly lower temperatures than LDPE. In the reaction, gaseous ethylene monomer (and very commonly additional α-olefin comonomers) is/are polymerized by multi-site transition metal Ziegler-Natta type catalysts to produce a substantially linear polymer structure with branching that, compared to LDPE, exhibits significantly more but shorter branches. Long chain branching is absent in LLDPE.

LLDPE can be a polyethylene homopolymer but is more commonly produced commercially as a random copolymer or random terpolymer. Most commercial LLDPE is copolymerized with at least one C3-C20 α-olefin of which 1-butene, 1-hexene, and 1-octene are the most typical.

Many producers of LDPE polymer also manufacture LLDPE polymer. Non-limiting examples of commercial LLDPE grades from the LDPE manufacturers listed above are marketed and sold under the tradenames Dow™ LLDPE and Dowlex™ (Dow), ExxonMobil™ LLDPE and ExxonMobil™ NTX LLDPE (ExxonMobil), SINOPEC LLDPE (Sinopec), SABIC® LLDPE (Sabic), Borealis LLDPE and Borstar® (Borealis), HIFOR® and HIFOR Xtreme® (Westlake), NOVAPOL® and SCLAIR® and SURPASS® (Nova), and NOVATEC®-LL (Japan Polyethylene).

“Polyethylene-based OBC” (referred to herein as OBC) is a multi-block LLDPE copolymer containing harder crystallizable LLDPE copolymer “blocks” alternating with amorphous softer LLDPE copolymer “blocks” that are not randomly distributed—that is, in a controlled (non-random) block sequence. The softer block comprises a higher amount of comonomer (most common are C3-C20 α-olefin) than the harder block. OBC is produced in a reactor by tandem catalysis using two “post-metallocene” (non-metallocene single-site and/or non-metallocene single-site capable) catalysts—one for polymerization of each block. Polymer synthesis occurs by transferring the polymer chain from one catalyst to the other (and vice-versa) and is referred to as “chain shuttling copolymerization”. An example of OBC includes, but is not limited to, the INFUSE™ OBC product line from Dow. In the commercially produced INFUSE™ OBC product line, the copolymer is 1-octene in both the harder and softer blocks.

The polyethylenes in the foamable sheet provided herein can have a melt flow index from about 0.1 to about 25 grams per 10 minutes at 190° C. In some embodiments, the melt flow index of the polyethylenes is from about 0.3 to about 20 grams per 10 minutes at 190° C. or from about 0.5 to about 15 grams per 10 minutes at 190° C. The “melt flow index” (MFI) value for polyethylenes provided herein is defined and measured according to ASTM D1238 at 190° C. using a 2.16 kg plunger for 10 minutes. The test time may be reduced for relatively high melt flow resins.

The MFI can provide a measure of flow characteristics of a polymer and is an indication of the molecular weight and processability of a polymer material. High MFI values correspond to low viscosities. If the MFI values are too high, extrusion according to the present disclosure may not be satisfactorily carried out. Problems associated with MFI values that are too high can include low pressures during extrusion, problems setting the thickness profile, uneven cooling profile due to low melt viscosity, poor melt strength, and/or machine problems. Conversely, low MFI values can correspond to high viscosities. MFI values that are too low can cause high pressures during melt processing, sheet quality and profile problems, and higher extrusion temperatures which cause a risk of chemical foaming agent decomposition and activation.

The above MFI ranges may be important for foaming processes because they can reflect the viscosity of the material, which has an effect on the foaming. Without being bound by any theory, it is believed there are several reasons why particular MFI values may be more effective. A lower MFI material may improve some physical properties as the molecular chain length is greater, creating more energy needed for chains to flow when a stress is applied. Also, the longer the molecular chain (MW), the more crystal entities the chain can crystallize, thus providing more strength through intermolecular ties. However, at too low an MFI, the viscosity can become too high. On the other hand, polymers with higher MFI values can have shorter chains. Therefore, in a given volume of a material with higher MFI values, there may be more chain ends on a microscopic level relative to polymers having a lower MFI, which can rotate and create free volume due to the space needed for such rotation (e.g., rotation occurring above the Tg, or glass transition temperature of the polymer). This can increase the free volume and enable an easy flow under stress forces which may cause cell degradation and “foam collapse” of the foamed polymer blend.

In addition to the polymers, the compositions fed into the extruders may also contain additives compatible with producing the disclosed polyethylene foams. Common additives include, but are not limited to, chemical foaming agents (CFA), crosslinking promoters, organic peroxides, antioxidants, lubricants, processing aids, thermal stabilizers, colorants, flame retardants, antistatic agents, electrostatic dissipative agents, nucleating agents, plasticizers, antimicrobials, fungicides, light stabilizers, UV absorbents, anti-blocking agents, fillers, deodorizers, odor adsorbers, anti-fogging agents, volatile organic compound (VOC) adsorbers, semi-volatile organic compound (SVOC) adsorbers, thickeners, cell size stabilizers, metal deactivators, chemical foaming agent (CFA) decomposition accelerants, chemical foaming agent (CFA) suppressants, optical clarifiers, and combinations thereof.

In some embodiments, the foam composition can contain a chemical foaming agent (CFA). In some embodiments, the extrusion temperature for the foam composition can be at least 10° C. below the thermal decomposition initiation temperature of the chemical foaming agent. If the extrusion temperature exceeds the thermal decomposition temperature of the foaming agent, then the foaming agent may decompose, resulting in undesirable “prefoaming.”

In some embodiments, the foam composition can include a variety of different chemical foaming agents and can include exothermic and endothermic types. Examples of chemical foaming agents include, but are not limited to, azo compounds, hydrazine compounds, carbazides, tetrazoles, nitroso compounds, and carbonates. In addition, a chemical foaming agent may be employed alone or in any combination. One chemical foaming agent that can be used in some embodiments is azodicarbonamide (ADCA). Two examples of commercially produced ADCA chemical foaming agents are UNIFOAM™ TC-18I (100% ADCA) made by P.T. Lauten Otsuka Chemical and VINYFOR™ AC-961 (≥90% ADCA) made by EIWA Chemical. ADCA's thermal decomposition typically occurs at temperatures between about 190 to 230° C. In some embodiments, in order to prevent ADCA from thermally decomposing in the extruder, extruding temperature can be maintained at or below 190° C.

The amount of chemical foaming agent in a foam composition can be less than or equal to about 30 PHR, about 20 PHR, about 15 PHR, or about 11 PHR of the composition. In some embodiments, the amount of chemical foaming agent in a foam composition can be greater than or equal to about 2 PHR, about 4 PHR, about 6 PHR, or about 8 PHR of the composition. In some embodiments, the amount of chemical foaming agent in a foam composition can be about 2-30 PHR, about 4-20 PHR, about 6-15 PHR, or about 8-11 PHR of the composition. In some embodiments, the amount of chemical foaming agent in a foam composition can be about 1-30 wt. %, about 3-20 wt. %, about 5-14 wt. %, about 5-10 wt. %, or about 6-9 wt. % of the composition. In some embodiments, the amount of chemical foaming agent can depend on the unfoamed sheet thickness, desired foam thickness, desired foam density, materials being extruded, crosslinking percentage, type of chemical foaming agent (different foaming agents can generate significantly different quantities of gas), among others.

In some embodiments, the above listed amounts of chemical foaming agent can be specific to ADCA. In some embodiments, other foaming agents can produce varying amounts of volumetric gas per mass of CFA and can be considered accordingly. For example, when comparing ADCA to the chemical foaming agent p-toluenesulfonyl semicarbazide (TSS), if a foamable sheet contains 40 PHR ADCA, about 63 PHR TSS may be required to generate about the same amount gas during the foaming step.

In some embodiments, the amount of additive(s) other than the chemical foaming agent(s) in a foam composition can be less than or equal to about 40 PHR, about 30 PHR, about 25 PHR, or about 20 PHR of the composition. In some embodiments, the amount of additive(s) other than the chemical foaming agent(s) in a foam composition can be greater than or equal to about 1 PHR, about 3 PHR, about 4 PHR, or about 5 PHR of the composition. In some embodiments, the amount of additive(s) other than the chemical foaming agent(s) in a foam composition can be about 1-40 PHR, about 3-30 PHR, about 4-25 PHR, or about 5-20 PHR of the composition. In some embodiments, the amount of additive(s) other than the chemical foaming agent(s) in a foam composition can be about 1-35 wt. %, about 2-25 wt. %, about 3-20 wt. %, or about 4-16 wt. %, of the foam composition.

In some embodiments, the foam composition may comprise one or more antioxidant additives. In some embodiments, the antioxidant additive(s) can be in the form of a masterbatch. In some embodiments, antioxidant additive masterbatches may include but are not limited to PM13633 (Techmer PM), PT213 (Toray Plastics), PM14809 (Techmer PM), etc., each of which can contain custom blends of commonly used polyolefin antioxidants tailored for the manufacturing process and foam end use performance requirements. In some embodiments, an amount of antioxidant masterbatch in a foam composition can be less than or equal to about 10 PHR, 8 PHR, or 6 PHR of the composition. In some embodiments, the amount of antioxidant masterbatch in the foam composition can be greater than or equal to 1 PHR, 2 PHR, 3 PHR, or 4 PHR of the composition. In some embodiments, the amount of antioxidant masterbatch in the foam composition can be about 1-10 PHR, 1-8 PHR, 1-6 PHR, 2-6 PHR, or 2-4 PHR of the composition. In some embodiments, the amount of antioxidant masterbatch in the foam composition can be about 0.1-10 wt. %, about 0.25-8 wt. %, about 0.5-6 wt. %, about 1-4 wt. %, about 1.5-4 wt. %, or about 1.5-3.5 wt. % of the foam composition.

It is important to note that antioxidant manufacturers and antioxidant distributors will recommend one or more specific antioxidants, recommend usage ratios between the recommended antioxidants, and suggest letdown ratios for specific foam compositions upon disclosure of the manufacturing process and end use performance requirements. Generally, masterbatches of tailored antioxidant blends are used by manufacturers of polyethylene foams. Exemplary manufacturers of antioxidants for polyethylene include, but are not limited to, Adeka, BASF, Clariant, SI Group, and Songwong.

In some embodiments, the foam composition may comprise one or more processing aid additives. In some embodiments, the processing aid additive can be in the form of a masterbatch. In some embodiments, the processing aid additive masterbatches may include but are not limited to TPM11166 (distributed by Techmer PM) and PM125000 (compounded by Techmer PM). In some embodiments, an amount of processing aid masterbatch in a foam composition can be less than or equal to about 5 PHR, 4 PHR, or 3 PHR of the composition. In some embodiments, the amount of processing aid masterbatch in the foam composition can be greater than or equal to 1 PHR, 2 PHR, or 3 PHR, of the composition. In some embodiments, the amount of processing aid masterbatch in the foam composition can be about 1-5 PHR, 1-4 PHR, 1-3 PHR, 2-4 PHR, or 2-3 PHR of the composition. In some embodiments, the amount of processing aid masterbatch in the foam composition can be about 0.1-6 wt. %, about 0.1-5 wt. %, about 0.25-5 wt. %, about 0.5-5 wt. %, about 0.5-4 wt. %, about 0.5-3 wt. %, about 0.5-2 wt. %, about 1-2 wt. %, or about 1.5-2 wt. % of the foam composition.

In some embodiments, the foam composition may comprise one or more chemical foaming agent (CFA) decomposition suppressant additives. In some embodiments, the CFA decomposition suppressant additives can be in the form of a masterbatch. In some embodiments, the CFA decomposition suppressant additive masterbatch may include but is not limited to Toray Plastics (America) masterbatch part number PT120 (compounded by Techmer PM). In some embodiments, an amount of CFA decomposition suppressant masterbatch in a foam composition can be less than or equal to about 10 PHR, 8 PHR, or 6 PHR of the composition. In some embodiments, the amount of CFA decomposition suppressant masterbatch in the foam composition can be greater than or equal to 1 PHR, 2 PHR, 3 PHR, or 4 PHR of the composition. In some embodiments, the amount of CFA decomposition suppressant masterbatch in the foam composition can be about 1-10 PHR, 1-8 PHR, 1-6 PHR, 2-6 PHR, or 2-4 PHR of the composition. In some embodiments, the amount of CFA decomposition suppressant masterbatch in the foam composition can be about 1-10 wt. %, about 1-8 wt. %, about 1-6 wt. %, about 1-4 wt. %, about 1.5-4 wt. %, or about 2-4 wt. % of the foam composition.

In some embodiments, the foam composition may comprise one or more anti-block additives. In some embodiments, the anti-block additives can be in the form of a masterbatch. In some embodiments, the anti-block additive masterbatches may include but are not limited to TPM1823 talc anti-block, TPM1922 diatomaceous earth anti-block, and TPM14287 calcium carbonate anti-block (all distributed by Techmer PM). In some embodiments, an amount of anti-block masterbatch in a foam composition can be less than or equal to about 10 PHR, 8 PHR, or 6 PHR of the composition. In some embodiments, the amount of anti-block masterbatch in the foam composition can be greater than or equal to 2 PHR, 3 PHR, 4 PHR, or 5 PHR of the composition. In some embodiments, the amount of anti-block masterbatch in the foam composition can be about 1-10 PHR, 2-8 PHR, 2-6 PHR, 3-6 PHR, or 4-6 PHR of the composition. In some embodiments, the amount of anti-block masterbatch in the foam composition can be about 1-10 wt. %, about 1-8 wt. %, about 1-6 wt. %, about 1-4 wt. %, about 2-6 wt. %, about 2-4 wt. %, about 2.5-3.5 wt. %, or about 3 wt. % of the foam composition.

In some embodiments, the foam composition may comprise one or more colorant additives. In some embodiments, the colorant additives can be in the form of a masterbatch. In some embodiments, the colorant additive masterbatches may include but are not limited to 62B17226 (black, Penn Color), PM55274 (white-tint, Techmer PM), etc. In some embodiments, an amount of colorant masterbatch in a foam composition can be less than or equal to about 15 PHR, 13 PHR, or 11 PHR of the composition. In some embodiments, the amount of colorant masterbatch in the foam composition can be greater than or equal to 2 PHR, 3 PHR, or 4 PHR of the composition. In some embodiments, the amount of colorant masterbatch in the foam composition can be about 2-15 PHR, 2-13 PHR, 2-11 PHR, 3-13 PHR, or 4-11 PHR of the composition. In some embodiments, the amount of colorant masterbatch in the foam composition can be about 1-12 wt. %, about 1-10 wt. %, about 1-9 wt. %, about 2-9 wt. %, or about 3-9 wt. % of the foam composition.

It is important to note that there are many compounders of color masterbatches worldwide which produce both “off the shelf” color masterbatches for distribution and custom color masterbatches based on the foam manufacturing process and end use color requirements. Exemplary compounders of color masterbatches for polyethylene include, but are not limited to, Techmer PM, Penn Color, Tosaf, Modern Dispersions (MDI), Colors For Plastics, Peacock Colors, Coloron Plastics, Clariant, etc.

In some embodiments, a foam composition may comprise a black colorant masterbatch. For example, an amount of black colorant in the foam composition can be less than or equal to 15 PHR, 13 PHR, or 11 PHR of the composition. In some embodiments, an amount of black colorant masterbatch in the foam composition can be greater than or equal to 4 PHR, 5 PHR, or 6 PHR of the composition. In some embodiments, the amount of black colorant masterbatch in the foam composition can be about 4-15 PHR, 5-13 PHR, or 6-11 PHR of the composition. In some embodiments, the amount of black colorant masterbatch in the foam composition can be about 4-12 wt. %, about 4-11 wt. %, about 5-10 wt. %, or about 6-9 wt. % of the foam composition.

In some embodiments, a foam composition may comprise a white-tint colorant masterbatch. For example, an amount of white-tint colorant masterbatch in the foam composition can be less than or equal to 10 PHR, 8 PHR, or 7 PHR of the composition. In some embodiments, an amount of white-tint colorant masterbatch in the foam composition can be greater than or equal to 2 PHR, 3 PHR, or 4 PHR of the composition. In some embodiments, the amount of white-tint colorant masterbatch in the foam composition can be about 2-10 PHR, about 3-8 PHR, or about 4-7 PHR of the composition. In some embodiments, the amount of white-tint colorant masterbatch in the foam composition can be about 1-8 wt. %, about 1-7 wt. %, about 1-6 wt. %, or about 2-6 wt. % of the foam composition.

Regardless of how ingredients of the foam composition are fed into the extruder, the shearing force and mixing within an extruder can be sufficient to produce a homogenous layer (otherwise referred to herein as a sheet, film, structure, etc.). Co-rotating and counter-rotating twin screw extruders can provide sufficient shearing force and mixing thru the extruder barrel to extrude a sheet with uniform properties.

Specific energy can be an indicator of how much work is being applied during the extrusion of the ingredients and how intensive the extrusion process is. Specific energy is defined as the energy applied to a material being processed by the extruder, normalized to a per kilogram basis. The specific energy can be quantified in units of kilowatts of applied energy per total material fed in kilograms per hour. Specific energy can be calculated according to the formula:

$$Specific Energy = \frac{KW ( applied )}{feedrate ( \frac{kg}{hr} )} , where \\ KW ( applied ) = \frac{\begin{matrix}KW ( motor rating ) * ( \% torque from maximum \\ allowable in decimal form ) * RPM ( actual running \\ RPM ) * 0.97 ( gearbox efficiency )\end{matrix}}{Max RPM ( capability of extruder )}$$

Specific energy can be used to quantify the amount of shearing and mixing of the ingredients within the extruder. Extruders used to form the foamable sheets disclosed herein can be capable of producing a specific energy of at least about 0.020 kW·hr/kg, at least about 0.025 kW·hr/kg, at least about 0.050 kW·hr/kg, or at least about 0.100 kW·hr/kg.

If the difference between the decomposition temperature of the thermally decomposable foaming agent and the melting point of the polymer with the highest melting point is high, then a catalyst for foaming agent decomposition may be used. Exemplary catalysts include, but are not limited to, zinc oxide, magnesium oxide, calcium stearate, glycerin, and urea. The lower temperature limit for extrusion can be that of the polymer with the highest melting point. If the extrusion temperature drops below the melting temperature of the polymer with the highest melting point, then undesirable “unmelts” may appear. Upon foaming, the sheet that was extruded below this lower temperature limit can exhibit uneven thickness, a non-uniform cell structure, pockets of cell collapse, and/or other undesirable attributes.

Regardless of whether the foaming agents are physical, chemical, or a combination, typical extrusion foaming can generate polymer sheets (e.g., layers, films, structures) where both primary surfaces may be significantly rougher than equivalent structures produced in the disclosed method. The surface profile of a foam sheet can be important in many applications and thus extrusion foamed sheets may not be used for these applications. These applications can include a smooth foam surface to obtain desired properties such as improving the percentage contact area when a pressure sensitive adhesive (PSA) is applied onto the foam surface; ease of lamination to a film, fabric, fiber layer, and a leather; percentage contact area in the lamination; and/or visual aesthetics; etc. PCT Publication WO 2016109544, which is hereby incorporated in its entirety by reference, includes examples illustrating the difference in surface roughness between extrusion foamed polymer sheets and equivalent foamed polymer sheets produced by the disclosed method.

The rougher surfaces of extrusion foamed articles can be generally caused by larger sized cells (when compared to the foams produced according to the present disclosure). Although the cell size and cell size distribution may not matter in most commercial applications, because surface roughness is a function of cell size, foams with larger cells can be less desirable than foams with smaller cells for applications requiring a smooth foam surface.

The thickness of the unfoamed extruded sheet can be about 0.1 to about 30 mm, about 0.2 to about 25 mm, about 0.3 to about 20 mm, or about 0.4 to about 15 mm. In some embodiments, the unfoamed extruded sheet can have a thickness of about 0.1-5 mm, about 0.5-3 mm, about 1-2 mm, or about 1-1.5 mm. In some embodiments, the unfoamed extruded sheet can have a thickness of less than or equal to about 5 mm, about 3 mm, about 2 mm, about 1.5 mm, about 1 mm, or about 0.5 mm. In some embodiments, the unfoamed extruded sheet can have a thickness of greater than or equal to about 0.1 mm, about 0.5 mm, about 1 mm, about 1.5 mm, about 2 mm, or about 3 mm.

In the present disclosure, the thickness of the unfoamed extruded sheet is measured using a thickness gauge where the sheet is placed on a flat level surface and contacted by a spring loaded plunger incorporated with the gauge. A 3 mm hemispherical diameter tip is attached to the plunger and contacts the sheet at 26.5+/−3.5 gram-force.

There is a difference between “physical” crosslinking and “chemical” crosslinking. In chemical crosslinking, the crosslinks are generated with crosslinking promoters but without the use of ionizing radiation. Chemical crosslinking typically involves using peroxides, silanes, or vinylsilanes. In peroxide crosslinking processes, the crosslinking typically occurs in the extrusion die. For silane and vinylsilane crosslinking processes, the crosslinking typically occurs post-extrusion in a secondary operation where the crosslinking of the extruded material is accelerated with heat and moisture. Regardless of the chemical crosslinking method, chemically crosslinked foam sheets can typically exhibit primary surfaces that are significantly rougher than equivalent structures produced in the disclosed method. The surface profile of a foam sheet can be critical in many applications and thus chemically crosslinked foam sheets may not be used for certain applications. These applications can include a smooth foam surface to obtain desired properties such as improving the percentage contact area when a pressure sensitive adhesive (PSA) is applied onto the foam surface; ease of lamination to a film, fabric, fiber layer, and a leather; percentage contact area in the lamination; and/or visual aesthetics; etc. PCT Publication WO 2016109544 includes examples illustrating the difference in surface roughness between chemically crosslinked foamed polymer sheets and equivalent foamed polymer sheets produced by the disclosed method.

The rougher surfaces of chemically crosslinked foamed articles can be generally caused by larger sized cells (when compared to the foams produced according to the present disclosure). Although the cell size and size distribution may not matter in most commercial applications, because surface roughness is a function of cell size, foams with larger cells can be less desirable than foams with smaller cells for applications requiring a smooth foam surface.

Examples of ionizing radiation include, but are not limited to, alpha, beta (electron beams), x-ray, gamma, and neutron. Among them, an electron beam having uniform energy can be used to crosslink the foamable sheet. Exposure time, frequency of irradiation (i.e., number of passes or number of exposures to radiation), and/or acceleration voltage upon irradiation with an electron beam can vary widely depending on the intended crosslinking degree and the thickness of the unfoamed sheet. However, the ionizing radiation can generally be in the range of from about 10 to about 500 kGy, about 20 to about 300 kGy, or about 20 to about 200 kGy. If the exposure is too low, then crosslinking is too low such that cell stability may not be maintained upon foaming. If the exposure is too high, the irradiated sheet may curl and buckle excessively upon foaming making it difficult to produce a flat and uniform foamed sheet. Also, a highly irradiated sheet may be highly crosslinked, where the crosslinking significantly reduces the ability of the polymer system to substantially elongate. Poor elongation of the polymer system may cause the sheet to tear and burst upon foaming in situations where the expansion of the foam exceeds the ultimate elongation property of the irradiated composition. Also, the unfoamed sheet may be softened by exothermic heat release upon exposure to the electron beam radiation such that the structure can deform when the exposure is too high. In addition, the polymer components may also be degraded from excessive polymer chain scission.

The unfoamed sheet may be irradiated up to four separate times, no more than twice, or only once. If the irradiation frequency is more than about four times, the polymer components may suffer degradation so that upon foaming, for example, uniform cells will not be created in the resulting foam. When the thickness of the extruded sheet is greater than about 4 mm, irradiating each primary surface of the sheet with an ionized radiation can make the degree of crosslinking for the full depth of the sheet more uniform.

Irradiation with an electron beam provides an advantage in that extruded sheets having various thicknesses can be effectively crosslinked by controlling the acceleration voltage of the electrons. The acceleration voltage can generally be in the range of from about 200 to about 1500 kV, about 300 to about 1200 kV, or about 400 to about 1000 kV. If the acceleration voltage is less than about 200 kV, then the radiation may not reach the inner portion of the extruded sheet. As a result, the cells in the inner portion can be coarse and uneven on foaming. Additionally, acceleration voltage that is too low for a given thickness profile can cause arcing, resulting in “pinholes” or “tunnels” in the foamed structure. On the other hand, if the acceleration voltage is greater than about 1500 kV, then the polymers may degrade from exposure to excessive radiation.

Regardless of the type of ionizing radiation selected, crosslinking is performed so that the composition of the extruded structure is crosslinked to about 15 to about 75%, about 20 to about 60%, 25 to about 50%, or about 30% to about 40% as measured by the “Toray Gel Fraction Percentage Method.” According to the “Toray Gel Fraction Percentage Method,” tetralin solvent is used to dissolve non-crosslinked components in a composition. In principle, the non-crosslinked material is dissolved in tetralin and the crosslinking degree is expressed as the weight percentage of crosslinked material in the entire composition. The apparatus used to determine the percent of polymer crosslinking includes: 100 mesh (0.0045 inch wire diameter) Type 304 stainless steel bags; numbered wires and clips; a Miyamoto thermostatic oil bath apparatus; an analytical balance; a fume hood; a gas burner; a high temperature oven; an anti-static gun; and three 3.5 liter wide mouth stainless steel containers with lids. Reagents and materials used include tetralin high molecular weight solvent, acetone, and silicone oil. Specifically, an empty wire mesh bag is weighed and the weight recorded. For each sample, 100 milligrams±5 milligrams of sample is weighed out and transferred to the wire mesh bag. The weight of the wire mesh bag and the sample, typically in the form of thinly sliced foam cuttings, is recorded. Each bag is attached to the corresponding number wire and clips. When the solvent temperature reaches 130° C., the bundle (bag and sample) is immersed in the solvent. The samples are shaken up and down about 5 or 6 times to loosen any air bubbles and fully wet the samples. The samples are attached to an agitator and agitated for three (3) hours so that the solvent can dissolve the foam. The samples are then cooled in a fume hood. The samples are washed by shaking up and down about 7 or 8 times in a container of primary acetone. The samples are washed a second time in a second acetone wash. The washed samples are washed once more in a third container of fresh acetone as above. The samples are then hung in a fume hood to evaporate the acetone for about 1 to about 5 minutes. The samples are then dried in a drying oven for about 1 hour at 120° C. The samples are cooled for a minimum of about 15 minutes. The wire mesh bag is weighed on an analytical balance and the weight is recorded. Crosslinking is then calculated using the formula 100*(C-A)/(B-A), where A=empty wire mesh bag weight; B=wire bag weight+foam sample before immersion in tetralin; and C=wire bag weight+dissolved sample after immersion in tetralin.

A crosslinking promoter was not added into the example formulations of the present disclosure. However, a crosslinking promoter can optionally be used to reduce the exposure of the foamable sheet to ionizing radiation to obtain a desired gel. Suitable crosslinking promoters include, but are not limited to, commercially available difunctional, trifunctional, tetrafunctional, pentafunctional, and higher functionality monomers. Such crosslinking monomers are available in liquid, solid, pellet, and powder forms. Examples include, but are not limited to, acrylates or methacrylates such as 1,6-hexanediol diacrylate, 1,6-hexanediol dimethacrylate, ethylene glycol diacrylate, ethylene glycol dimethacrylate, trimethylol propane trimethacrylate, tetramethylol methane triacrylate, 1,9-nonanediol dimethacrylate and 1,10-decanediol dimethacrylate; allyl esters of carboxylic acid (such as trimellitic acid triallyl ester, pyromellitic acid triallyl ester, and oxalic acid diallyl ester); allyl esters of cyanulic acid or isocyanulic acid such as triallyl cyanurate and triallyl isocyanurate; maleimide compounds such as N-phenyl maleimide and N,N′-m-phenylene bismaleimide; compounds having at least two tribonds such as phthalic acid dipropagyl and maleic acid dipropagyl; and divinylbenzene. Additionally, such crosslinking promoters may be used alone or in any combination.

Crosslinking promoters can vary in crosslinking efficiency based on the ionizing radiation dosage, the polymers being crosslinked, the chemical structure of the monomer, the number of functional groups on the monomer, and/or whether the monomer is a liquid or a powder.

Crosslinks may be generated using a variety of different techniques and can be formed both intermolecularly, between different polymer molecules, and intramolecularly, between portions of a single polymer molecule. Such techniques include, but are not limited to, (a) exposing the polymer molecules to ionizing radiation, (b) providing crosslinking promoters which are separate from a polymer chain and exposing the crosslinking promoters and polymers to ionizing radiation, and/or (c) providing polymer chains which incorporate a crosslinking promoter as a functional group which can form a crosslink or be activated to form a crosslink.

After irradiating the extruded sheet, foaming may be accomplished by heating the crosslinked sheet to a temperature higher than the decomposition temperature of the thermally decomposable blowing agent. In some embodiments, the foaming can be performed at about 200-260° C. or about 220-240° C. in a continuous process. A continuous foaming process can be preferred over a batch process for production of a continuous foam sheet.

The foaming can be typically conducted by heating the crosslinked sheet with molten salt, radiant heaters, vertical or horizontal hot air oven, microwave energy, or a combination of these methods. The foaming may also be conducted in an impregnation process using, for example, nitrogen in an autoclave, followed by a free foaming via molten salt, radiant heaters, vertical or horizontal hot air oven, microwave energy, or a combination of these methods. Optionally, before foaming, the crosslinked sheet can be softened with preheating. This can help stabilize the expansion of the structure upon foaming, particularly with thick and stiff sheets.

In some embodiments, the polyethylene foam structure can include at least about 70 wt. %, at least about 75 wt. %, at least about 80 wt. %, or at least about 85 wt. % LDPE, LLPDE, or a combination of LDPE and LLDPE, and OBC. In some embodiments, the polyethylene foam structure can be at most about 90 wt. %, at most about 87 wt. %, at most about 84 wt. %, or at most about 81 wt. % LDPE, LLPDE, or a combination of LDPE and LLDPE, and OBC. In some embodiments, the polyethylene foam structure can be about 70-90 wt. %, about 75-87 wt. %, or about 80-84 wt. % LDPE, LLPDE, or a combination of LDPE and LLDPE, and OBC.

In some embodiments, an amount of LDPE, LLDPE, or a combination of LDPE and LLDPE in the polyethylene foam structure can be at least about 30 wt. %, at least about 35 wt. %, at least about 40 wt. %, at least about 45 wt. %, at least about 48 wt. %, at least about 50 wt. %, at least about 52 wt. %, at least about 55 wt. %, at least about 58 wt. %, or at least about 60 wt. % LDPE, LLDPE, or a combination of LDPE and LLDPE. In some embodiments, the amount of LDPE, LLDPE, or a combination thereof in the polyethylene foam structure can be at most about 42 wt. %, at most about 45 wt. %, at most about 50 wt. %, at most about 52 wt. %, at most about 55 wt. %, at most about 58 wt. %, at most about 60 wt. %, at most about 62 wt. %, at most about 65 wt. %, at most about 68 wt. %, at most about 70 wt. %, or at most about 75 wt. % LDPE, LLDPE, or a combination of LDPE and LLDPE. In some embodiments, the amount of LDPE, LLDPE, or a combination thereof in the polyethylene foam structure can be about 30-80 wt. %, about 35-75 wt. %, about 35-70 wt. %, about 40-65 wt. %, about 40-60 wt. %, about 40-55 wt. %, about 40-50 wt. %, about 45-65 wt. %, about 45-60 wt. %, about 45-55 wt. %, about 48-62 wt. %, about 48-60 wt. %, about 48-58 wt. %, about 50-65 wt. %, or about 50-60 wt. % LDPE, LLDPE, or a combination of LDPE and LLDPE.

In some embodiments, an amount of LDPE, LLDPE, or a combination of LDPE and LLDPE in the polyethylene foam structure can be greater than or equal to about 15, 20, 25, 30, 35, 40, 45, or 50 PHR LDPE, LLDPE, or a combination of LDPE and LLDPE. In some embodiments, an amount of LDPE, LLDPE, or a combination of LDPE and LLDPE in the polyethylene foam structure be less than or equal to about 50, 55, 60, 65, 70, 75, 80, or 85 PHR LDPE, LLDPE, or a combination of LDPE and LLDPE. In some embodiments, an amount of LDPE, LLDPE, or a combination of LDPE and LLDPE in the polyethylene foam structure can be about 15-85, 15-80, 15-75, 20-85, 20-80, 20-75, 50-85, 50-80, 50-75, 50-70, 50-65, 50-60, 60-85, 60-80, 60-75, 70-85, or 70-80 PHR LDPE, LLDPE, or a combination of LDPE and LLDPE.

In some embodiments, an amount of LDPE in the polyethylene foam structure can be at least about 10 wt. %, at least about 15 wt. %, at least about 18 wt. %, at least about 20 wt. %, at least about 22 wt. %, at least about 24 wt. %, at least about 26 wt. %, at least about 30 wt. %, at least about 35 wt. %, at least about 38 wt. %, at least about 40 wt. %, at least about 42 wt. %, at least about 45 wt. %, at least about 48 wt. %, at least about 50 wt. %, or at least about 55 wt. % LDPE. In some embodiments, an amount of LDPE in the polyethylene foam structure can be at most about 40 wt. %, at most about 45 wt. %, at most about 48 wt. %, at most about 50 wt. %, at most about 52 wt. %, at most about 55 wt. %, at most about 60 wt. %, at most about 62 wt. %, at most about 65 wt. %, at most about 70 wt. %, at most about 73 wt. %, at most about 75 wt. %, or at most about 80 wt. % LDPE. In some embodiments, an amount of LDPE in the polyethylene foam structure can be about 10-80 wt. %, about 15-75 wt. %, about 20-70 wt. %, about 24-65 wt. %, about 20-30 wt. %, about 35-45 wt. %, about 35-55 wt. %, about 35-50 wt. %, about 45-55 wt. %, about 45-60 wt. %, about 50-60 wt. %, or about 50-65 wt. % LDPE.

In some embodiments, an amount of LDPE in the polyethylene foam structure can be greater than or equal to about 20, 25, 30, 35, 40, 45, or 50 PHR LDPE. In some embodiments, an amount of LDPE in the polyethylene foam structure can be less than or equal to about 50, 55, 60, 65, 70, 75, or 80 PHR LDPE. In some embodiments, an amount of LDPE in the polyethylene foam structure can be about 20-80, 20-75, 25-80, 25-75, 30-80, 30-75, 30-70, 30-65, 30-60, 30-55, 30-50, 50-80, 50-75, 50-70, 50-60, 60-80, 60-75, or 70-80 PHR LDPE.

In some embodiments, an amount of LLDPE in the polyethylene foam structure be at least about 5 wt. %, at least about 8 wt. %, at least about 10 wt. %, at least about 12 wt. %, at least about 15 wt. %, at least about 17 wt. %, at least about 20 wt. %, at least about 22 wt. %, at least about 24 wt. %, at least about 25 wt. %, at least about 26 wt. %, at least about 30 wt. %, or at least about 35 wt. % LLDPE. In some embodiments, an amount of LLDPE in the polyethylene foam structure can be at most about 30 wt. %, at most about 35 wt. %, at most about 40 wt. %, at most about 42 wt. %, at most about 44 wt. %, at most about 45 wt. %, at most about 46 wt. %, at most about 48 wt. %, at most about 50 wt. %, at most about 52 wt. %, at most about 55 wt. %, at most about 60 wt. %, or at most about 65 wt. % LLDPE. In some embodiments, an amount of LLDPE in the polyethylene foam structure can be about 5-65 wt. %, about 5-60 wt. %, about 10-55 wt. %, about 15-50 wt. %, about 10-20 wt. %, about 10-30 wt. %, about 20-30 wt. %, about 20-40 wt. %, about 20-50 wt. %, about 20-55 wt. %, about 40-50 wt. %, about 40-55 wt. %, about 45-55 wt. %, or about 45-50 wt. % LLDPE.

In some embodiments, an amount of LLDPE in the polyethylene foam structure can be greater than or equal to about 15, 20, 25, 30, 35, 40, 45, or 50 PHR LLDPE. In some embodiments, an amount of LLDPE in the polyethylene foam structure can be less than or equal to about 50, 55, 57.5, 60, 65, or 70 PHR LLDPE. In some embodiments, an amount of LLDPE in the polyethylene foam structure can be about 15-70, 15-65, 15-60, 20-70, 20-65, 20-60, 20-40, 20-30, 30-70, 30-65, 30-60, 50-70, 50-65, or 50-60 PHR LLDPE.

In some embodiments, an amount of OBC in the polyethylene foam structure be at least about 10 wt. %, at least about 15 wt. %, at least about 20 wt. %, at least about 22 wt. %, at least about 25 wt. %, at least about 27 wt. %, at least about 30 wt. %, at least about 32 wt. %, at least about 35 wt. %, at least about 38 wt. %, or at least about 40 wt. % OBC. In some embodiments, an amount of OBC in the polyethylene foam structure can be at most about 20 wt. %, at most about 25 wt. %, at most about 30 wt. %, at most about 32 wt. %, at most about 35 wt. %, at most about 37 wt. %, at most about 40 wt. %, at most about 45 wt. %, at most about 48 wt. %, or at most about 50 wt. % OBC. In some embodiments, an amount of OBC in the polyethylene foam structure can be about 10-50 wt. %, about 15-45 wt. %, about 20-40 wt. %, about 20-35 wt. %, about 20-30 wt. %, about 22-35 wt. %, about 22-32 wt. %, about 25-35 wt. %, about 30-45 wt. %, or about 30-40 wt. % OBC.

In some embodiments, an amount of OBC in the polyethylene foam structure can be greater than or equal to about 15, 20, 25, 26, 30, 35, 40 PHR OBC. In some embodiments, an amount of OBC in the polyethylene foam structure can be less than or equal to about 42, 42.5, 43, 45, 50, or 55 PHR OBC. In some embodiments, an amount of OBC in the polyethylene foam structure can be about 15-55, 15-50, 15-45, 15-40, 20-55, 20-50, 20-45, 20-40, 25-55, 25-50, 25-45, 25-40, 25-35, 30-55, 30-50, 30-45, 30-40, 35-55, 35-50, 35-45, 40-55, or 40-50 PHR OBC.

During the foaming step, the chemical foaming agent can decompose into one or more gases and one or more solids. The gas generation from decomposing the CFA can cause the unfoamed crosslinked sheet to expand into a cellular structure. For the case of ADCA, decomposition products include gases, solid organic decomposition products that can further decompose into more gases and other solid organics, and/or solid decomposition products. In some embodiments, once fully foamed, the polyethylene foam structure can be essentially or substantially free of the CFA (e.g., ADCA). In some embodiments, the mass loss due to gas formation from CFA (e.g., ADCA) decomposition (along with subsequent secondary decomposition reactions) ranges from about 30 to about 40%, with the remainder (about 60 to about 70%) mass comprising various solid organic decomposition products. In some embodiments, these solid decomposition products typically do not impart functional or useful properties to the polyethylene foam structure. In some embodiments, the amount of CFA (e.g., ADCA) solid decomposition products in a polyethylene foam structure can be less than or equal to about 21 PHR, about 14 PHR, about 10.5 PHR, or about 7.7 PHR CFA solid decomposition products. In some embodiments, the amount of CFA (e.g., ADCA) solid decomposition products in a polyethylene foam structure can be greater than or equal to about 1.2 PHR, about 2.44 PHR, about 3.6 PHR, or about 4.8 PHR of the CFA solid decomposition products. In some embodiments, the amount of CFA (e.g., ADCA) solid decomposition products in a polyethylene foam structure can be about 1.2-21 PHR, about 2.4-14 PHR, about 3.6-10.5 PHR, or about 4.8-7.7 PHR CFA solid decomposition products. In some embodiments, the amount of CFA (e.g., ADCA) solid decomposition products in a polyethylene foam structure can be about 0.6-21 wt. %, about 1.8-14 wt. %, about 3-9.8 wt. %, about 3-7 wt. %, or about 3.6.3-wt. % CFA solid decomposition products.

In some embodiments, the amount of additive(s) other than the decomposed chemical foaming agent(s) in a polyethylene foam structure can be less than or equal to about 40 PHR, about 30 PHR, about 25 PHR, or about 20 PHR additives. In some embodiments, the amount of additive(s) other than the decomposed chemical foaming agent(s) in a polyethylene foam structure can be greater than or equal to about 1 PHR, about 3 PHR, about 4 PHR, or about 5 PHR additives. In some embodiments, the amount of additive(s) other than the decomposed chemical foaming agent(s) in a polyethylene foam structure can be about 1-40 PHR, about 3-30 PHR, about 4-25 PHR, or about 5-20 PHR additives. In some embodiments, the amount of additive(s) other than the decomposed chemical foaming agent(s) in a polyethylene foam structure can be about 1-35 wt. %, about 2-25 wt. %, about 3-20 wt. %, or about 4-16 wt. % additives.

In some embodiments, an amount of antioxidant masterbatch in a polyethylene foam structure can be less than or equal to about 10 PHR, 8 PHR, or 6 PHR. In some embodiments, the amount of antioxidant masterbatch in the polyethylene foam structure can be greater than or equal to 1 PHR, 2 PHR, 3 PHR, or 4 PHR. In some embodiments, the amount of antioxidant masterbatch in the polyethylene foam structure can be about 1-10 PHR, 1-8 PHR, 1-6 PHR, 2-6 PHR, or 2-4 PHR. In some embodiments, the amount of antioxidant masterbatch in the polyethylene foam structure can be about 0.1-10 wt. %, about 0.25-8 wt. %, about 0.5-6 wt. %, about 1-4 wt. %, about 1.5-4 wt. %, or about 1.5-3.5 wt. %.

In some embodiments, an amount of processing aid masterbatch in a polyethylene foam structure can be less than or equal to about 5 PHR, 4 PHR, or 3 PHR. In some embodiments, the amount of processing aid masterbatch in the polyethylene foam structure can be greater than or equal to 1 PHR, 2 PHR, or 3 PHR. In some embodiments, the amount of processing aid masterbatch in the polyethylene foam structure can be about 1-5 PHR, 1-4 PHR, 1-3 PHR, 2-4 PHR, or 2-3 PHR. In some embodiments, the amount of processing aid masterbatch in the polyethylene foam structure can be about 0.1-6 wt. %, about 0.1-5 wt. %, about 0.25-5 wt. %, about 0.5-5 wt. %, about 0.5-4 wt. %, about 0.5-3 wt. %, about 0.5-2 wt. %, about 1-2 wt. %, or about 1.5-2 wt. %.

In some embodiments, an amount of CFA decomposition suppressant masterbatch in a polyethylene foam structure can be less than or equal to about 10 PHR, 8 PHR, or 6 PHR. In some embodiments, the amount of CFA decomposition suppressant masterbatch in the polyethylene foam structure can be greater than or equal to 1 PHR, 2 PHR, 3 PHR, or 4 PHR. In some embodiments, the amount of CFA decomposition suppressant masterbatch in the polyethylene foam structure can be about 1-10 PHR, 1-8 PHR, 1-6 PHR, 2-6 PHR, or 2-4 PHR. In some embodiments, the amount of CFA decomposition suppressant masterbatch in the polyethylene foam structure can be about 1-10 wt. %, about 1-8 wt. %, about 1-6 wt. %, about 1-4 wt. %, about 1.5-4 wt. %, or about 2-4 wt. %.

In some embodiments, an amount of anti-block masterbatch in a polyethylene foam structure can be less than or equal to about 10 PHR, 8 PHR, or 6 PHR. In some embodiments, the amount of anti-block masterbatch in the polyethylene foam structure can be greater than or equal to 2 PHR, 3 PHR, 4 PHR, or 5 PHR. In some embodiments, the amount of anti-block masterbatch in the polyethylene foam structure can be about 1-10 PHR, 2-8 PHR, 2-6 PHR, 3-6 PHR, or 4-6 PHR. In some embodiments, the amount of anti-block masterbatch in the polyethylene foam structure can be about 1-10 wt. %, about 1-8 wt. %, about 1-6 wt. %, about 1-4 wt. %, about 2-6 wt. %, about 2-4 wt. %, about 2.5-3.5 wt. %, or about 3 wt. %.

In some embodiments, an amount of colorant masterbatch in a polyethylene foam structure can be less than or equal to about 15 PHR, 13 PHR, or 11 PHR. In some embodiments, the amount of colorant masterbatch in the polyethylene foam structure can be greater than or equal to 2 PHR, 3 PHR, or 4 PHR. In some embodiments, the amount of colorant masterbatch in the polyethylene foam structure can be about 2-15 PHR, 2-13 PHR, 2-11 PHR, 3-13 PHR, or 4-11 PHR colorant. In some embodiments, the amount of colorant masterbatch in the polyethylene foam structure can be about 1-12 wt. %, about 1-10 wt. %, about 1-9 wt. %, about 2-9 wt. %, or about 3-9 wt. %.

In some embodiments, a polyethylene foam structure may comprise a black colorant masterbatch. For example, an amount of black colorant masterbatch in the polyethylene foam structure can be less than or equal to 15 PHR, 13 PHR, or 11 PHR. In some embodiments, an amount of black colorant masterbatch in the polyethylene foam structure can be greater than or equal to 4 PHR, 5 PHR, or 6 PHR. In some embodiments, the amount of black colorant masterbatch in the polyethylene foam structure can be about 4-15 PHR, 5-13 PHR, or 6-11 PHR. In some embodiments, the amount of black colorant masterbatch in the polyethylene foam structure can be about 4-12 wt. %, about 4-11 wt. %, about 5-10 wt. %, or about 6-9 wt. %.

In some embodiments, a polyethylene foam structure may comprise a white-tint colorant masterbatch. For example, an amount of white-tint colorant masterbatch in the polyethylene foam structure can be less than or equal to 10 PHR, 8 PHR, or 7 PHR. In some embodiments, an amount of white-tint colorant masterbatch in the polyethylene foam structure can be greater than or equal to 2 PHR, 3 PHR, or 4 PHR. In some embodiments, the amount of white-tint colorant masterbatch in the polyethylene foam structure can be about 2-10 PHR, 3-8 PHR, or 4-7 PHR. In some embodiments, the amount of white-tint colorant masterbatch in the polyethylene foam structure can be about 1-8 wt. %, about 1-7 wt. %, about 1-6 wt. %, or about 2-6 wt. %.

The density of the foam sheet can be defined and measured using section or “overall” density, rather than a “core” density, as measured by JIS K6767. The foam sheets produced using the above-described method can yield foams with a section, or “overall” density of about 15-200 kg/m³, about 30-150 kg/m³, or about 50-125 kg/m³. In some embodiments, the section density can be controlled by the amount of blowing agent and the thickness of the extruded sheet. If the density of the foam sheet is less than about 15 kg/m³, then the sheet may not foam efficiently due to a large amount of chemical blowing agent to attain the density. Additionally, if the density of the sheet is less than about 15 kg/m³, then the expansion of the sheet during the foaming step may become increasingly difficult to control. Furthermore, if the density of the foam sheet is less than about 15 kg/m³, then the foam may become increasingly prone to cell collapse. Thus, it may be difficult to produce a foam sheet of uniform section density and thickness at a density less than about 15 kg/m³.

The foam sheet is not limited to a section density of about 200 kg/m³. A foam having a section density of about 300 kg/m³, about 400 kg/m³, or about 500 kg/m³ may also be produced. However, the foam sheet may have a density of less than about 200 kg/m³ since greater densities can be generally cost prohibitive when compared to other materials which can be used in a given application.

In some embodiments, the foam produced using the above method may have closed cells. In some embodiments, at least 90% of the cells have undamaged cell walls, at least 95%, or more than 98% when measured using a pycnometer according to ASTM D6226 or ISO 4590.

In some embodiments, the average cell size can be from about 0.05 to about 1.0 mm, or from about 0.1 to about 0.7 mm when measured according to ASTM D3576. If the average cell size is less than about 0.05 mm, then the density of the foam structure can typically be greater than 200 kg/m3. If the average cell size is larger than 1 mm, the foam may have an uneven surface. There is also a possibility of the foam being undesirably torn if the population of cells in the foam does not have the preferred average cell size. This can occur when the foam is stretched, when a shear force is applied to the foam, and/or when portions of it are subjected to a secondary process. In some embodiments, the cell size in the foam may have a bimodal distribution representing a population of cells in the core of the foam which are relatively round and a population of cells in the skin near the surfaces of the foam structure which are relatively flat, thin, and/or oblong.

The overall thickness of the polyethylene foam sheet is measured according to JIS K6767 and can be about 0.2 mm to about 50 mm, about 0.4 mm to about 40 mm, about 0.6 mm to about 30 mm, or about 0.8 mm to about 20 mm. If the thickness is less than about 0.2 mm, then foaming may not be efficient due to significant gas loss from the primary surface(s). If the thickness is greater than about 50 mm, expansion during the foaming step can become increasingly difficult to control. Thus, it can be increasingly more difficult to produce a polyethylene foam sheet with uniform section density and thickness. In some embodiments, the polyethylene foam sheet can have a thickness of about 0.5-5 mm, about 1-4 mm, or about 2-3 mm.

In some embodiments, the desired foam thickness can be obtained by a secondary process such as slicing, skiving, or bonding. Slicing, skiving, or bonding can produce a thickness range of about 0.1 mm to about 100 mm.

The disclosed polyethylene foams can be used in a variety of applications. In one embodiment, the polyethylene foams can be the substrate of a single sided or double-sided adhesive foam tape. In this embodiment, a pressure sensitive adhesive layer is disposed on at least a portion of one or both primary foam surfaces. Any pressure sensitive adhesive known in the art may be used. Examples of such pressure sensitive adhesives are acrylic polymers, polyurethanes, thermoplastic elastomers, block copolymers, polyolefins, silicones, rubber-based adhesives, copolymers of ethylhexylacrylate and acrylic acid, copolymers of isooctyl acrylate and acrylic acid, blends or acrylic adhesives and rubber based adhesives as well as combinations of the foregoing. The foam tapes can be commercially produced and sold as rolls or as flat sheets and can be used for diverse applications such as for mounting, adhesion, gasketing, weatherstripping, cushioning, and the like.

In some embodiments, the polyethylene foams can be laminates containing a foam layer disclosed herein and a laminate layer. The laminate layer can be applied to a side (i.e., surface) of the foam. In these laminates, the polyethylene foam can, for example, be combined with a film and/or foil. Examples of suitable materials for such layers include, but are not limited to, polyvinyl chloride (PVC); thermoplastic polyolefin (TPO); thermoplastic urethane (TPU); fabrics such as polyester, polypropylene, cloth and other fabrics; leather and/or fiber layers such as non-wovens. Such layers may be manufactured using standard techniques that are well known to those of ordinary skill in the art. Importantly, the polyethylene foam may be laminated on one or both sides with these materials and may include multiple other layers.

In these laminates, a layer may be joined to an adjacent layer by means of chemical bonds, mechanical means, or combinations thereof. Adjacent laminate layers may also be affixed to each other by any other means including the use of attractive forces between materials having opposite electromagnetic charges or attractive forces present between materials which both have either a predominantly hydrophobic character or a predominantly hydrophilic character.

In other embodiments, the polyethylene foams or laminates can be used in automobile interior parts such as door panels, door rolls, door inserts, door stuffers, trunk stuffers, armrests, center consoles, seat cushions, seat backs, headrests, seat back panels, knee bolsters, or a headliner. These polyethylene foams or laminates can also be used in furniture (e.g., commercial, office, and residential furniture) such as chair cushions, chair backs, sofa cushions, sofa trims, recliner cushions, recliner trims, couch cushions, couch trim, sleeper cushions, or sleeper trims. These polyethylene foams or laminates can also be used as a component in walls such as modular walls, moveable walls, wall panels, modular panels, office system panels, room dividers, or portable partitions. The polyethylene foams or laminates can also be used as a component in storage casing (e.g., commercial, office and residential) which can be either mobile or stationary. Furthermore, the polyethylene foams or laminates can also be used in coverings such as chair cushion coverings, chair back coverings, armrest coverings, sofa coverings, sofa cushion coverings, recliner cushion coverings, recliner coverings, couch cushion coverings, couch coverings, sleeper cushion coverings, sleeper coverings, wall coverings, and architectural coverings.

To satisfy the requirements of any of the above applications, the disclosed structures of the present disclosure may be subjected to various secondary processes, including and not limited to, embossing, corona or plasma treatment, surface roughening, surface smoothing, perforation or microperforation, splicing, slicing, skiving, layering, bonding, and hole punching.

### EXAMPLES

### Raw Materials for Examples

The following Table 1 provides a list of various components and descriptions of those components used in the following Examples.

TABLE 1
Materials Used to Produce Crosslinked Polyethylene Foam

| Component | Type | Manufacturer | MFI | Description/Notes |
|---|---|---|---|---|
| Novapol ® | LDPE | Nova | 1.9-2.7 | commercially produced low density polyethylene |
| LF-0219-A | | | (2.16 kg, 190° C.) | |
| Hifor ® | LLDPE (LLDPE/ | Westlake | 2.0 typical | commercially produced linear low density |
| LF1040AA | butene copolymer) | | (2.16 kg, 190° C.) | polyethylene-butene copolymer |
| Infuse ™ | OBC (LLDPE/ | Dow | 0.75-1.25 | commercially produced linear low density |
| OBC9107 | octene copolymer) | | (2.16 kg, 190° C.) | polyethylene-octene olefin block copolymer |
| Unifoam ™ | chemical foaming | P.T. Lauten | — | commercially produced azodicarbonamide |
| TC-18I | agent (ADCA) | Otsuka Chemical | | |
| Vinyfor ™ | chemical foaming | Eiwa Chemical | — | commercially produced blend of azodicarbonamide |
| AC-961 | agent (ADCA blend) | Industry Company | | (≥90%) and other ingredient(s) |
| PM13633 | anti-oxidant | Techmer PM | — | a Toray Plastics (America) standard antioxidant |
| | masterbatch | | | masterbatch for polyolefin foam, compounded by |
| | (LDPE carrier) | | | Techmer PM, consisting of 14% antioxidants, |
| | | | | 0.35% calcium stearate, and 85.65% low density |
| | | | | polyethylene (LDPE) carrier resin |
| PT213 | anti-oxidant | Toray Plastics | — | a Toray Plastics (America) standard antioxidant |
| | masterbatch | (America) | | masterbatch for polyolefin foam, compounded by |
| | (LLDPE/hexene | | | Toray Plastics (America), consisting of 9.01% |
| | copolymer carrier) | | | antioxidants, 0.25% extrusion processing aid |
| | | | | blend, 0.22% calcium stearate, and 90.52% linear |
| | | | | low density polyethylene-hexene copolymer carrier |
| | | | | resin |
| PM14809 | anti-oxidant | Techmer PM | — | a Toray Plastics (America) standard antioxidant |
| | masterbatch | | | masterbatch for polyethylene foam, compounded |
| | (LDPE carrier) | | | by Techmer PM, consisting of 19.5% antioxidants |
| | | | | and 80.5% low density polyethylene (LDPE) carrier |
| | | | | resin |
| TPM11166 | process aid | Techmer PM | — | commercially produced extrusion processing aid |
| | masterbatch | | | blend sourced by Techmer PM |
| | (LLDPE/butene | | | |
| | copolymer carrier) | | | |
| PT120 | ADCA thermal | Techmer PM | — | a Toray Plastics (America) standard ADCA thermal |
| | decompostion | | | decomposition suppressant masterbatch, compounded |
| | suppressant | | | by Techmer PM, consisting of 5% ADCA thermal |
| | masterbatch | | | decomposition suppressant and 95% low density |
| | (LDPE carrier) | | | polyethylene (LDPE) carrier resin |
| TPM1823 | anti-block | Techmer PM | — | commercially produced talc anti-block masterbatch |
| | masterbatch | | | sourced by Techmer PM |
| | (LDPE carrier) | | | |
| 62B17226 | black masterbatch | Penn Color | — | a custom masterbatch for Toray Plastics (America), |
| | (LLDPE/hexene | | | compounded by Penn Color, consisting of 20% carbon |
| | copolymer carrier) | | | black and 80% linear low density polyethylene- |
| | | | | hexene copolymer carrier resin |
| PM55274 | white-tint | Techmer PM | — | a custom masterbatch for Toray Plastics (America), |
| | masterbatch | | | formulated and compounded by Techmer PM, consisting |
| | (LDPE carrier) | | | of 40% titanium dioxide, about 2.5% other colorant(s) and |
| | | | | ingredient(s), and about 57.5% low density |
| | | | | polyethylene (LDPE) carrier resin |

### Conversion Process for Examples

The following Table 2 provides the formulations for Examples 1, 2a, 2b, 2c, 3a, 3b, 3c, 3d, and 3e.

TABLE 2
Crosslinked Polyethylene Foam - Formulations

| | FORMULATIONS | | | | |
|---|---|---|---|---|---|
| | resins (PHR & overall %) | | | | |
| | | LLDPE (LLDPE/ | OBC (LLDPE/ | additives (PHR & overall %) | |
| | LDPE | butene copoly) | octene copoly) | chemical foaming agent (ADCA) | |
| | Novapol ® | Hifor ® | Infuse ™ | Unifoam ™ | Vinyfor ™ |
| example ID | LF-0219-A | LF1040AA | OBC9107 | TC-18I | AC-961 |
| Example 1 | 60 | | 40 | 9.1 | |
| (uncolored) | 52.39% | | 34.93% | 7.95% | |
| Example 2a | 30 | 30 | 40 | 9.3 | |
| (black) | 24.58% | 24.58% | 32.77% | 7.62% | |
| Example 2b | | 60 | 40 | 9.3 | |
| (black) | | 49.16% | 32.77% | 7.62% | |
| Example 2c | | 57.5 | 42.5 | 8.56 | |
| (black) | | 46.92% | 34.68% | 6.98% | |
| Example 3a | 60 | | 40 | 9.5 | |
| (white) | 48.58% | | 32.39% | 7.69% | |
| Example 3b | 30 | 30 | 40 | 9.5 | |
| (white) | 24.29% | 24.29% | 32.39% | 7.69% | |
| Example 3c | 50 | 20 | 30 | 10.72 | |
| (white) | 38.25% | 15.30% | 22.95% | 8.20% | |
| Example 3d | 50 | 20 | 30 | | 8.7 |
| (white) | 41.95% | 16.78% | 25.17% | | 7.30% |
| Example 3e | 74 | | 26 | | 8.7 |
| (white) | 62.08% | | 21.81% | | 7.30% |

| | FORMULATIONS | | | | | | | |
|---|---|---|---|---|---|---|---|---|
| | additives (PHR & overall %) | | | | | | | |
| | | | | | ADCA | | color masterbatch (black = | |
| | | | | process aid | thermal decomp. | | LLDPE/butene copolymer carrier, | |
| | | | | (LLDPE/butene | suppressant | anti-block | white-tint = LDPE carrier) | |
| | anti-oxidant masterbatch (LDPE carrier) | | | copolymer carrier) | (LDPE carrier) | (LDPE carrier) | 62B17226 | PM55274 |
| example ID | PM13633 | PT213 | PM14809 | TPM11166 | PT120 | TPM1823 | black | white-tint |
| Example 1 | 3.25 | | | 2.18 | | | | |
| (uncolored) | 2.84% | | | 1.90% | | | | |
| Example 2a | 3.25 | | | 2 | | | 7.5 | |
| (black) | 2.66% | | | 1.64% | | | 6.15% | |
| Example 2b | 3.25 | | | 2 | | | 7.5 | |
| (black) | 2.66% | | | 1.64% | | | 6.15% | |
| Example 2c | | 3.5 | | | | | 10.5 | |
| (black) | | 2.86% | | | | | 8.57% | |
| Example 3a | | | 4 | 2 | 4 | | | 4 |
| (white) | | | 3.24% | 1.62% | 3.24% | | | 3.24% |
| Example 3b | | | 4 | 2 | 4 | | | 4 |
| (white) | | | 3.24% | 1.62% | 3.24% | | | 3.24% |
| Example 3c | | | 4 | 2 | 3 | 5 | | 6 |
| (white) | | | 3.06% | 1.53% | 2.29% | 3.82% | | 4.59% |
| Example 3d | | | 2 | 2 | | | | 6.5 |
| (white) | | | 1.68% | 1.68% | | | | 5.45% |
| Example 3e | | | 2 | 2 | | | | 6.5 |
| (white) | | | 1.68% | 1.68% | | | | 5.45% |

The following Table 3 provides the extrusion, irradiation, and foaming properties of the polyethylene foam of Examples 1, 2a, 2b, 2c, 3a, 3b, 3c, 3d, and 3e.

TABLE 3
Crosslinked Polyethylene Foam - Processing Parameters

| | EXTRUSION | | | | IRRADIATION | |
|---|---|---|---|---|---|---|
| | | specific energy | | average unfoamed | line | |
| | | of extrusion | melt temp. | sheet thickness | dosage calc. | voltage |
| example ID | extruder type | (kW · hr/kg) | (° C.) | (mm) | (kGy) | (kV) |
| Example 1 | co-rotating | 0.15 | 167 | 0.80 | 54 | 600 |
| (uncolored) | twin screw | | | | | |
| Example 2a | co-rotating | 0.18 | 176 | 0.69 | 110 | 500 |
| (black) | twin screw | | | | | |
| Example 2b | co-rotating | 0.19 | 176 | 0.72 | 121 | 500 |
| (black) | twin screw | | | | | |
| Example 2c | co-rotating | 0.19 | 170 | 0.73 | 98 | 500 |
| (black) | twin screw | | | | | |
| Example 3a | co-rotating | 0.14 | 169 | 0.70 | 67 | 500 |
| (white) | twin screw | | | | | |
| Example 3b | co-rotating | 0.16 | 172 | 0.70 | 65 | 500 |
| (white) | twin screw | | | | | |
| Example 3c | co-rotating | 0.15 | 169 | 0.67 | 78 | 500 |
| (white) | twin screw | | | | | |
| Example 3d | co-rotating | 0.027 | 167 | 0.67 | 80 | 500 |
| (white) | twin screw | | | | | |
| Example 3e | co-rotating | 0.026 | 162 | 0.67 | 75 | 500 |
| (white) | twin screw | | | | | |

| | FOAMING | | | | | |
|---|---|---|---|---|---|---|
| | maximum | foaming | | average | average | average |
| | foaming temp. | residence time | foaming | thickness | overall density | gel |
| example ID | (° C.) | (sec) | type | (mm) | (kg/m³) | (%) |
| Example 1 | 236 | 101 | molten salt | 1.77 | 67.4 | 28 |
| (uncolored) | | | & rad htrs | | | |
| Example 2a | 235 | not recorded | molten salt | 1.49 | 91.0 | 53 |
| (black) | | | & rad htrs | | | |
| Example 2b | 234 | not recorded | molten salt | 1.35 | 99.5 | 52 |
| (black) | | | & rad htrs | | | |
| Example 2c | 236 | not recorded | molten salt | 1.23 | 114.6 | 44 |
| (black) | | | & rad htrs | | | |
| Example 3a | 239 | 89 | molten salt | 1.47 | 73.4 | 30 |
| (white) | | | & rad htrs | | | |
| Example 3b | 239 | 87 | molten salt | 1.52 | 68.7 | 27 |
| (white) | | | & rad htrs | | | |
| Example 3c | 238 | 103 | molten salt | 1.57 | 62.6 | 35 |
| (white) | | | & rad htrs | | | |
| Example 3d | 235 | 85 | molten salt | 1.61 | 73.5 | 39 |
| (white) | | | & rad htrs | | | |
| Example 3e | 226 | 90 | molten salt | 1.78 | 71.5 | 41 |
| (white) | | | & rad htrs | | | |

This application discloses several numerical ranges in the text. The numerical ranges disclosed inherently support any range or value within the disclosed numerical ranges, including the endpoints, even though a precise range limitation is not stated verbatim in the specification because this disclosure can be practiced throughout the disclosed numerical ranges.

The above description is presented to enable a person skilled in the art to make and use the disclosure, and is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown, but is to be accorded the widest scope consistent with the principles and features disclosed herein. Finally, the entire disclosure of the patents and publications referred in this application are hereby incorporated herein by reference.

What is claimed is:

1. A polyethylene foam structure comprising:
40-65 wt. % low density polyethylene (LDPE), linear low density polyethylene (LLDPE), or a combination of LDPE and LLDPE; and
15-45 wt. % olefin block copolymer (OBC).

2. The polyethylene foam structure of claim 1, comprising 50-65 wt. % low density polyethylene (LDPE), linear low density polyethylene (LLDPE), or a combination of LDPE and LLDPE.

3. The polyethylene foam structure of claim 1, comprising 20-35 wt. % olefin block copolymer (OBC).

4. The polyethylene foam structure of claim 1, further comprising a chemical foaming agent in an amount of 5-15 wt. % prior to foaming.

5. The polyethylene foam structure of claim 1, further comprising an antioxidant masterbatch in an amount of 1-10 wt. %.

6. The polyethylene foam structure of claim 1, further comprising a processing aid masterbatch in an amount of 0.5-5 wt. %.

7. The polyethylene foam structure of claim 1, further comprising a chemical foaming agent decomposition suppressant masterbatch in an amount of 1-10 wt. %.

8. The polyethylene foam structure of claim 1, further comprising an anti-blocking agent masterbatch in an amount of 1-10 wt. %.

9. The polyethylene foam structure of claim 1, further comprising a colorant masterbatch in an amount of 1-12 wt. %.

10. The polyethylene foam structure of claim 1, comprising a density of 15-200 kg/m³.

11. The polyethylene foam structure of claim 1, comprising a crosslinking degree of 20-75%.

12. The polyethylene foam structure of claim 1, comprising an average closed cell size of 0.05-1.0 mm.

13. The polyethylene foam structure of claim 1, comprising a thickness of 0.2-50 mm.

14. A laminate comprising:
a polyethylene foam layer comprising:
40-65 wt. % low density polyethylene (LDPE), linear low density polyethylene (LLDPE), or a combination of LDPE and LLDPE; and
15-45 wt. % olefin block copolymer (OBC); and
a laminate layer on a side of the polyethylene foam layer.

15. The laminate of claim 14, wherein the laminate layer is a flexible film, fabric, or foil.

16. The laminate of claim 14, wherein the laminate layer is unfoamed or foamed.

17. An adhesive foam tape, comprising:
a polyethylene foam layer comprising:
40-65 wt. % low density polyethylene (LDPE), linear low density polyethylene (LLDPE), or a combination of LDPE and LLDPE; and
15-45 wt. % olefin block copolymer (OBC); and
a pressure sensitive adhesive layer on a side of the polyethylene foam layer.

18. The adhesive foam tape of claim 17, further comprising a second pressure sensitive adhesive layer on a side of the polyethylene foam layer opposite from the first pressure sensitive adhesive layer.

19. The adhesive foam tape of claim 17, wherein the adhesive foam tape is a roll or a flat sheet.

20. The adhesive foam tape of claim 17, wherein the pressure sensitive adhesive layer comprises one or more of acrylic polymers, polyurethanes, thermoplastic elastomers, block copolymers, polyolefins, silicones, rubber-based adhesives, copolymers of ethylhexylacrylate and acrylic acid, copolymers of isooctyl acrylate and acrylic acid, or combinations thereof.
